(19) United States
(12) Patent Application Publication
(10) Pub. No.: US 2002/0098293 A1
(43) Pub. Date: Jul. 25, 2002

(54) Method and apparatus for coating a substrate

(76) Inventors: Jeffrey L. Kokoschke, Faribault, MN (US); Clifford L. Taylor, Nerstrand, MN (US); Jonathan G. Little, Faribault, MN (US)

Correspondence Address: DORSEY & WHITNEY LLP, 50 SOUTH SIXTH STREET, MINNEAPOLIS, MN, 55402-1498, US

(21) Appl. No.: 09/768,191

(22) Filed: Jan. 23, 2001

(51) Int. Cl. B05C 1/06; B05D 3/02

(52) U.S. Cl. 427/428; 118/258

(57) ABSTRACT

A method and apparatus for applying a hydrophobic coating to a substrate in which the apparatus includes a pre-application zone with a controlled environment chamber, an application zone with a controlled environment chamber for application of the coating to a substrate and a post application zone.

### BACKGROUND OF THE INVENTION

1. Field of the Invention

The present invention relates generally to a method and apparatus for coating a substrate, and more particularly, to a method and apparatus for providing a substrate with a coating which, when applied, is sensitive to the ambient environment such as certain hydrophobic coatings. Still more specifically, the present invention relates to an in-line method and apparatus for providing the surface of a substrate with such a coating.

2. Description of the Prior Art

The prior art includes various compositions, coating materials and the like which are designed for application to substrate surfaces such as glass. These are commonly applied for the purpose of providing such substrate surface with high water repellency and high lubricity to facilitate cleaning of such surfaces. Examples of patents disclosing compositions for this purpose include U.S. Pat. Nos. 4,263,371 issued to Franz, 4,276,350 issued to Franz, 4,301,197 issued to Franz, 4,529,657 issued to Franz, 4,983,459 issued to Franz, 5,851,674 issued to Pellerite and 5,981,059 issued to Bright.

Many of the prior art systems for applying hydrophobic or anti-soiling compositions are manual or batch processes. This is often necessary because of the high reactivity of the hydrophobic or anti-soiling compositions. For this reason, among others, currently available hydrophobic or anti-soiling compositions do not readily lend themselves to continuous, in-line application processes.

Accordingly, there is a need in the art for an improved method and apparatus for providing a substrate with a hydrophobic or anti-soiling coating or other highly reactive coatings or compositions, and more particularly a need for a continuous, in-line application method and apparatus for providing a substrate surface with a hydrophobic or anti-soiling coating, despite the high reactivity of such compositions.

### SUMMARY OF THE INVENTION

In contrast to the prior art, the present invention relates to a continuous, in-line application method and apparatus for providing a hydrophobic or anti-soiling coating to the surface of a substrate. Although a variety of hydrophobic or anti-soiling compositions may be applied using the method and apparatus of the present invention, it is particularly applicable to the class of compositions which are highly reactive at ambient environmental conditions such as, but not limited to, the class of compositions described as perfluoroalkyl alkyl silanes. More specifically, the method and apparatus of the present invention has particularly applicability to a perfluoroalkyl alkyl silane.

Perfluoroalkyl alkyl silanes are extremely reactive compositions which are reactive at ambient humidity conditions and which are not conducive to continuous, in-line application processes. The method and apparatus of the present invention, however, overcomes these obstacles and facilitates the application of such a composition via a continuous, in-line process.

In general, the apparatus of the present invention includes an in-line system comprising a substrate pre-application treatment zone, an application zone in which the hydrophobic or anti-soiling composition is applied to the substrate and a post-application zone. More specifically, the pre-application treatment zone includes a zone in which the substrate is exposed to a controlled environment such as one of relatively high humidity or is otherwise provided with a layer of water vapor at least one monolayer thick on the substrate surface to be coated. Preferably, the humidity in this pre-application treatment zone is at least about 30% and more preferably between about 40% and 70%. If the humidity is too low, adhesion between the composition and the substrate will be adversely affected.

Following the pre-application treatment zone, the substrate is directed into an application zone in which the hydrophobic or anti-soiling composition is applied to the substrate surface to be coated. This coating can be applied by any means known in the art such as roll coating, immersion, bath, or the like. Preferably, in accordance with the present invention, the coating material is applied via a roll coating process to the bottom or lower surface of the substrate. The entire application zone is preferably maintained in a relatively dry (low humidity) environment in which the humidity is maintained at a level of less than 10%, more preferably less than 5%, and most preferably less than about 1%.

After application, the coated substrate is exposed to the post-application treatment zone which preferably is comprised of three sections: a first section for removing accumulated solution beads or droplets from the coated surface; a second section for providing the coated surface with a controlled environment of high humidity; and a third section for providing heat for purposes of increasing the speed at which the coating composition cures.

The method aspect of the present invention includes applying the coating composition to the substrate of a surface in which the surface has been previously exposed to an environment of high humidity or otherwise wetted. The coating composition is applied in a relatively dry environment with a humidity of less than 10%, more preferably less than 5%, and most preferably less than about 1%. Finally, the applied composition is cured.

Accordingly, it is the object of the present invention to provide an improved method and apparatus for applying a hydrophobic or anti-soiling coating to the surface of a substrate.

Another object of the present invention is to provide a continuous, in-line method and apparatus for providing a hydrophobic or anti-soiling coating to the surface of a substrate.

A further object of the present invention is to provide a continuous method and apparatus for applying a highly reactive coating such as a perfluoroalkyl alkyl silane coating composition to the surface of a substrate.

These and other objects of the present invention will become apparent with reference to the description of the preferred embodiment and the appended claims.

### BRIEF DESCRIPTION OF THE DRAWINGS

FIG. 1 is a schematic illustration of the system and apparatus of the present invention.

FIG. 2 is a side view of a portion of the application zone showing the application roller and associated composition reservoir.

FIG. 3 is an end view of a portion of the application zone showing the application roller and associated composition reservoir.

FIG. 4 is an end view showing the support mechanism for the substrate during passage through the system.

### DESCRIPTION OF THE PREFERRED EMBODIMENT

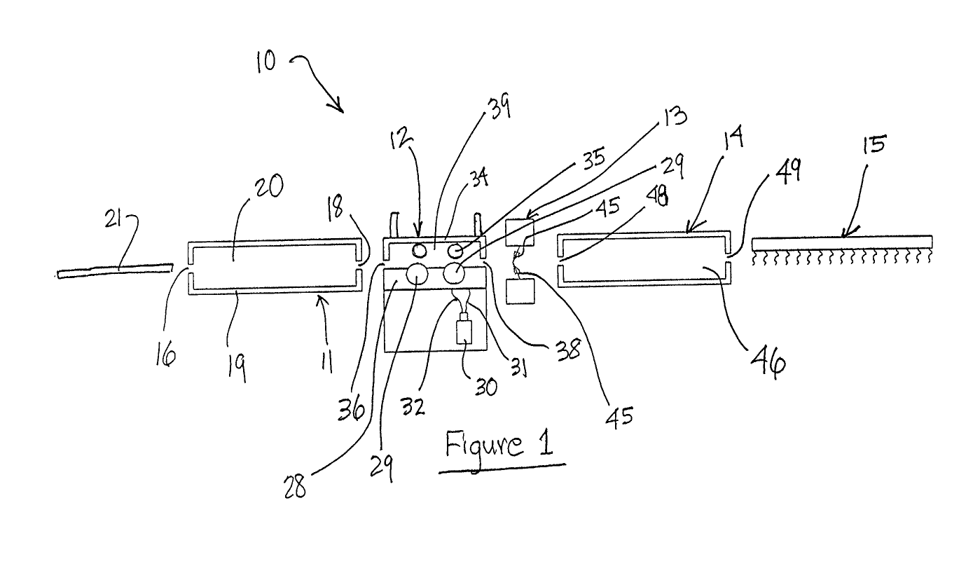

The present invention relates generally to a method and apparatus for applying a hydrophobic or anti-soiling composition to a substrate surface. Although the present invention is particularly applicable to substrates such as flat glass or plastic, it has broader application as well. Accordingly, as used herein, unless otherwise expressly limited, the term “substrate” or “substrate surface” shall mean and include the surface of glass, plastic or other material whose surface is flat or is curved or any other article having a surface which is desired to be coated with a hydrophobic or anti-soiling coating. Common examples would include CRT's, flat panel displays, mirrors and high reflective products, among others. Further, the term “hydrophobic” or “anti-soiling” as used herein shall mean a coating which provides a substrate surface with high water repellency or lubricity to facilitate the cleaning of such surface and the removal of smudges, fingerprints, streak lines and the like from the coated surface. Preferably, the substrate is transparent. Further, the substrate surface to be coated may be provided with an anti-reflection (AR) coating, if desired. FIG. 1 is a schematic representation of the system and apparatus 10 of the present invention. Specifically, this apparatus 10 is an in-line, continuous apparatus for applying a hydrophobic or anti-soiling composition to the surface of a substrate 21. The apparatus generally includes a pre-application treatment zone 11, an application zone 12, and a post-application treatment zone comprised of the sections 13, 14 and 15.

Although the method and apparatus of the present invention can be used with a variety of hydrophobic or anti-soiling compositions, it has particular applicability to compositions which are highly reactive at ambient humidity or other conditions such as those compositions characterized as perfluoroalkyl alkyl silanes. Accordingly, the preferred method and apparatus will be described with respect to the use of a perfluoroalkyl alkyl silane as the hydrophobic or anti-soiling composition.

With reference to FIG. 1, the pre-application treatment zone 11 provides a controlled environment for the substrate surface to be coated prior to application of the coating material. The pre-application treatment zone includes a housing or containment portion 19 having an inlet 16 and an outlet 18 for the substrate 21. The housing 19 defines an interior chamber or zone 20 in which the environment and other conditions are controlled for purposes of pre-treating the surface to be coated. In this pre-treatment chamber 20, conditions such as humidity and temperature can be maintained. Other pre-treatment steps such as cleaning the substrate surface or providing it with primers or other materials prior to application can also be performed in the chamber 20 if desired. Alternatively, those steps can be provided prior to entry into the pretreatment zone 11. In the method and apparatus of the present invention in which the hydrophobic or anti-soiling composition is a perfluoroalkyl alkyl silane, the chamber 20 is preferably maintained at a relatively high humidity level. Although various humidity levels will provide varying degrees of coating acceptability, the substrate surface in the pre-application zone 11 is preferably exposed to a humidity level of greater than about 30% and more preferably between about 40% and 75% prior to entry into the application zone 12. In the preferred method and apparatus, the exposure time is anticipated to be at least about 2 seconds and more preferably about 2 to 7 seconds, however, this exposure time can be varied as desired by increasing the travel speed of the substrate through the system and/or by varying the length of the pre-application treatment zone 11.

The apparatus shown in FIG. 1 facilitates a continuous process in which the substrate 21 to be coated is continuously fed into the end 16 of the pre-application zone 11, through the entire system and then out through the outlet end of the post-application treatment zone section 14. The means for moving the substrate through the system of FIG. 1 is illustrated best in FIG. 4. In the preferred embodiment, the substrate 21 to be coated is a sheet of flat glass which is supported on a plurality of spaced rotatable rollers 22 and 24. Specifically, a series of rollers 22 and a series of the rollers 24 are provided with, the rollers in each series being linerally spaced throughout the length of the system of FIG. 1. Each of the rollers 22 and 24 includes a shoulder portion 25 for supporting a peripheral edge portion of the first or bottom surface 26 of the substrate 21 as the substrate 21 is continuously moved throughout the system.

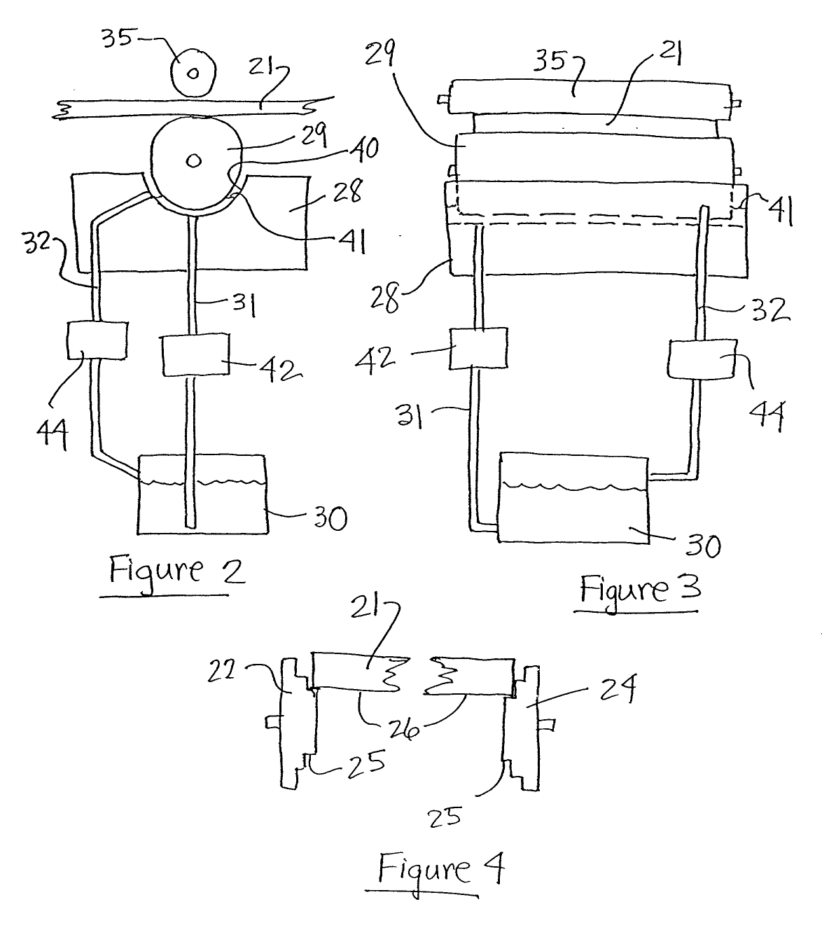

After passage through the pre-application treatment zone 11, the substrate 21 enters the application zone 12. In the preferred method and apparatus, the application zone 12 includes a housing 34 having a substrate inlet 36, a substrate outlet 38 and a controlled environment chamber 39. Exposed to and defining a portion of the chamber 39 is a roller support member 28 for containing the coating composition and for rotatively supporting one or more application rollers 29. Associated with the rollers 29 as more specifically shown in FIGS. 2 and 3 are a coating composition reservoir 30 and a composition inlet conduit 31 and an outlet conduit 32 for supplying coating composition to and draining coating composition from a composition application trough 40. A hold down roller 35 is positioned above at least one of the application rollers 29 in vertically spaced relationship for the purpose of maintaining coating engagement between the substrate surface 26 and the application rollers 29 during passage of the substrate 21 through the application zone 12.

In the application zone, the environment is maintained such that substantially all of the moisture has been removed. Thus, the controlled environment within the zone 39 is an environment of extremely low humidity. Preferably the humidity or moisture level within the zone 39 is maintained at a level less than 10%, more preferably less than 5%, and most preferably less than about 1%.

The structure of the application rollers 29 and their associated structure is illustrated best in FIGS. 2 and 3. As shown, the roller support 28 includes the recessed application trough 40 which conforms substantially to the exterior configuration of the roller, but is slightly spaced from the exterior surface of the roller 29 as shown. During operation, a fluid level 41 of the coating composition is maintained within the trough 40 so that as the roller 29 rotates, it picks up fluid 41 from the trough 40 for application to the first or bottom surface 26 of the substrate 21.

The fluid level 41 in the trough 40 is maintained by pumping coating composition fluid from the reservoir 30 into the bottom of the trough 40 through the inlet 31. In the preferred embodiment, this is performed by a peristaltic pump 42. During the coating process, the coating composition is preferably supplied to the trough 40 at a rate greater than that applied. Thus, the trough 40 is also provided with an outlet connected with an outlet conduit 32 provided for routing the excess fluid back into the reservoir 30. This outlet conduit 32 opens into the trough 40 at a position corresponding to the desired level of the fluid 41 to be maintained in the trough 40. When excess coating material exists in the trough 40, it flows by gravity back to the reservoir 30 through the conduit 32. A filter 44 is provided in the outlet conduit 32 to filter out lint, impurities, reacted polymer or any other contaminants or material prior to being returned to the reservoir 30. Various other pumps and/or filters may also be provided in the lines 31 and 32, if desired.

The roller 29 may be constructed of a variety of materials. In the preferred embodiment, however, the roller material should have several characteristics. First, it should be chemically compatible or stable relative to the particular coating composition to be applied and the solvent base of such composition. Secondly, the material of the roller 29 should have a surface tension that allows the coating solution in the trough 40 to wet the entire surface of the roller 29 and to remain wet, without drying out. Thirdly, the material of the roller 29 should be such that a relatively uniform thickness of the coating solution can be applied to the roller 29 and thus to the surface of the substrate 21.

With the structure shown in FIGS. 2 and 3, it can be seen that the coating composition is applied to the substrate surface 26 by a roll coating process from the bottom side of the substrate 21. It is contemplated, however, that the coating composition can also be applied to the top surface, or both surfaces, of the substrate, or can be applied using any other known application methods such as immersion, or the like. Further, it is contemplated that the application could be applied to substrates which are vertically oriented rather than horizontally oriented so that the coating material is actually applied to a vertically oriented surface of the substrate 21 which is moving generally horizontally or even vertically, through the system. Such a system has advantages in that the substrate can be supported on a single edge.

The post-application treatment zone which is comprised of the sections 13, 14 and 15 functions to remove excess coating composition from the coated substrate surface. The sections 13, 14 and 15 also provide an environment to increase the reaction or polymerization of the coating composition on the substrate and to provide heat for the purpose of speeding the cure of the composition.

More specifically, the section 13 is provided for the purpose of removing excess coating composition from the substrate 21. In the embodiment of FIG. 1, this includes one or more air knives 45. These air knives comprise a high volume of air to essentially blow off and remove excess liquid coating composition in the form of beads or droplets from the coated surface. This results in a coated surface which is relatively smooth and free of excess coating composition. Although the preferred embodiment utilizes the air knives 45 for accomplishing this function, it is contemplated that other means could be used as well such as a squeegees, water or solvent sprays, gravity, vacuum or one or more wiper blades with a combination of high and low energy surfaces.

After leaving the zone 13, the coated substrate enters the section 14 which provides a controlled environment for the coated substrate. The section 14 includes inlet 48 and outlet 49 ends for passage of the substrate 21 and a controlled environment zone 46 for controlling the environment for the coated substrate following application. Depending upon the particular coating composition utilized, this controlled environment zone 46 is designed to control the humidity, the temperature and/or provide other steps to the coated surface such as cleaning or priming. In the preferred apparatus, however, in which the application is a perfluoroalkyl alkyl silane, the environment of zone 46 is maintained at a relatively high humidity. Preferably the humidity within the zone 46 is at a level greater than about 30% and more preferably within the range of about 40% to 70% .

After leaving the section 14, the coated substrate is exposed to a section 15 which functions to provide heat to the coated surface. This significantly speeds up the coating composition curing process. Preferably, the conditions within the section 15 are maintained at a temperature of 300-600° F. and the coated glass is exposed to such temperatures for a period of 5 to 10 seconds. Without heat and at room temperature, the curing process can take up to a day or more.

Accordingly, the apparatus or system of the present invention relates to a device for coating a substrate surface with a hydrophobic or anti-soiling coating comprised of a perfluoroalkyl alkyl silane in which the apparatus includes an application zone maintained at controlled conditions in which the humidity is less than 10%, more preferably less than 5%, and most preferably less than about 1%. More specifically, the apparatus includes a pre-application treatment zone in which the conditions are maintained at a humidity level greater than 30% and more preferably between about 40% and 75%. The apparatus also preferably includes a post-application treatment zone which includes means for removing excess coating composition from the coated surface and for increasing the reaction and curing speed of the coated composition

Although the description of the preferred embodiment has been quite specific, it is contemplated that various modifications could be made without deviating from the spirit of the present invention. Accordingly, it is intended that the scope of the invention be dictated by the appended claims rather than by the description of the preferred embodiment.

1. An apparatus for applying a hydrophobic coating to a substrate comprising:
a pre-application zone with a controlled environment chamber and a substrate inlet and a substrate outlet;
an application zone with a controlled environment chamber and a substrate inlet and a substrate outlet;
a coating applicator in said application zone; and a post-application zone.

2. The apparatus of claim 1 being an apparatus for applying a coating whose reactivity is sensitive to ambient environmental conditions.

3. The apparatus of claim 1 wherein said applicator is a roller.

4. The apparatus of claim 1 including a substrate support, said substrate support supporting said substrate during passage through said pre-application zone, said application zone and said post-application zone.

5. The apparatus of claim 1 wherein said post application zone includes an excess coating removal zone and a heating zone.

6. The apparatus of claim 3 wherein said applicator includes a coating composition reservoir and an application trough for providing coating composition to said roller.

7. The apparatus of claim 6 including a coating composition supply passage from said reservoir to said trough and a coating composition return passage from said trough to said reservoir.

8. A method of applying a hydrophobic coating to a substrate comprising:
providing a substrate with a surface;
applying a hydrophobic coating to said surface at a humidity of no greater than 10%.

9. The method of claim 8 wherein said coating is applied at a humidity of no greater than 5%.

10. The method of claim 8 wherein said hydrophobic coating is a perfluoroalkyl alkyl silane.

11. The method of claim 8 including exposing the coated surface to a humidity of at least 30% after said application step.

12. The method of claim 8 including exposing said surface to a humidity of at least 30% prior to said application step.

13. The method of claim 8 including wetting said surface prior to said application step.

14. The method of claim 8 including exposing the coated surface to heat of at least about 300° F. after said application step.

15. The method of claim 8 including exposing said surface to a humidity of at least 30% prior to said application step and including exposing the coated surface to a humidity of at least 30after said application step.

16. The method of claim 15 wherein said hydrophobic coating is a perfluoroalkyl alkyl silane.

17. The method of claim 8 including providing a substrate in a generally horizontal position wherein said surface is a bottom surface.

18. The method of claim 17 including coating said surface with a roller.

19. The method of claim 18 including exposing said surface to a humidity of at least 30 prior to said application step.

20. The method of claim 19 including exposing the coated surface to a humidity of at least 30% after said application step.
